(19) United States
(12) Patent Application Publication
(10) Pub. No.: US 2014/0235739 A1
(43) Pub. Date: Aug. 21, 2014

(54) METHOD FOR PRODUCING TEMPLATE, METHOD FOR CHECKING TEMPLATE, AND TEMPLATE MATERIAL

(71) Applicant: KABUSHIKI KAISHA TOSHIBA, Tokyo (JP)

(72) Inventor: Seiji MORITA, Tokyo (JP)

(73) Assignee: KABUSHIKI KAISHA TOSHIBA, Tokyo (JP)

(21) Appl. No.: 14/013,769

(22) Filed: Aug. 29, 2013

(30) Foreign Application Priority Data
Feb. 21, 2013 (JP) 2013-032318

(51) Int. Cl. B29C 33/40; B29C 71/04; C08L 83/00; C08L 69/00; C08L 25/06; C08L 71/00; C08L 33/20; C08L 47/00; C08L 29/04; C08L 77/00; C08L 33/12; B29C 71/00; C08L 67/02

(52) U.S. Cl. CPC B29C 33/40; B29C 71/0009; B29C 71/04; C08L 83/00; C08L 69/00; C08L 25/06; C08L 67/02; C08L 33/20; C08L 47/00; C08L 29/04; C08L 77/00; C08L 33/12; C08L 71/00
USPC 521/128; 264/219; 264/40.1; 264/416; 525/474; 521/154; 525/464; 525/55; 525/56

(57) ABSTRACT

In one embodiment, a method for producing a template includes applying a resin to a first template having a first concavo-convex pattern, hardening the resin, releasing the hardened resin from the first template to produce a second template having a second concavo-convex pattern corresponding to the first concavo-convex pattern, and enlarging the second template.

### CROSS REFERENCE TO RELATED APPLICATION

This application is based upon and claims benefit of priority from the Japanese Patent Application No. 2013-32318, filed on Feb. 21, 2013, the entire contents of which are incorporated herein by reference.

### FIELD

Embodiments described herein relate generally to a method for producing a template, a method for checking a template, and a template material.

### BACKGROUND

As a technique for forming a fine pattern at low cost, an optical nanoimprint method has been known. This method is a method in which a template having irregularities corresponding to a desired pattern on a substrate is pressed against a photocrosslinkable organic material layer that is formed on a surface of the substrate by coating, and then irradiated with light to harden the organic material layer, and the template is released from the organic material layer to transfer the pattern. When there is a defect on a surface of the template, the defect is also transferred to the surface of the substrate. Therefore, a defect check of a template is performed.

In the conventional defect check of a template, a pattern face of the template has been scanned with an optical defect checking device equipped with a short-wavelength leaser (e.g., solid SHG laser with a wavelength of 193 nm) as a light source, a high-numerical aperture objective lens, and a polarization element optical system for detecting a fine defect and thus a defect is detected. However, the limit of size of a defect to be detected is about 20 nm due to the limit of optical resolution. Therefore, a defect smaller than the limit cannot be detected.

### BRIEF DESCRIPTION OF THE DRAWINGS

FIG. 1 is a process cross-sectional view illustrating a method for producing a template according to a first embodiment;

FIG. 2 is a process cross-sectional view subsequent to FIG. 1;

FIG. 3 is a process cross-sectional view subsequent to FIG. 2;

FIG. 4 is a view showing an aspect of stretching a copy template;

FIG. 5 is a view showing an aspect of stretching a copy template; and

FIGS. 6A to 6C are views showing a defect in each template.

### DETAILED DESCRIPTION

In one embodiment, a method for producing a template includes applying a resin to a first template having a first concavo-convex pattern, hardening the resin, releasing the hardened resin from the first template to produce a second template having a second concavo-convex pattern corresponding to the first concavo-convex pattern, and enlarging the second template.

Embodiments will now be explained with reference to the accompanying drawings.

### First Embodiment

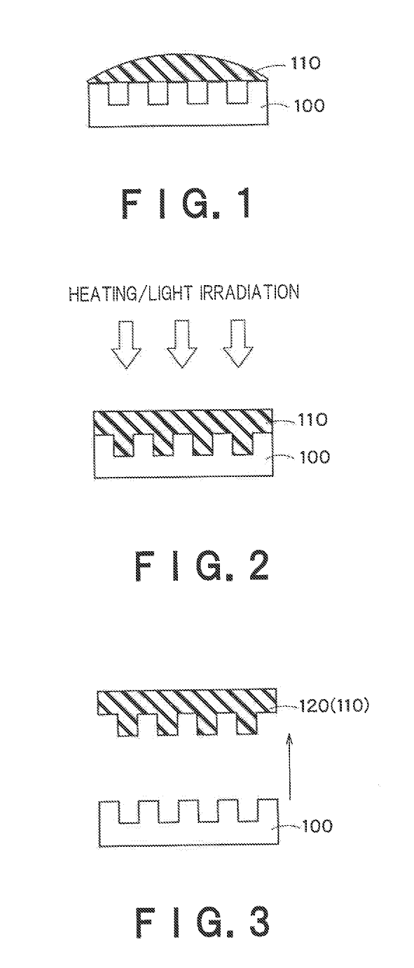

A method for producing a template according to a first embodiment will be described using FIGS. 1 to 6C.

As shown in FIG. 1, a master template 100 having a fine concavo-convex pattern (first template) is prepared. For example, the master template 100 has a concavo-convex pattern that is formed by plasma etching on one surface of a complete transparent quartz substrate.

Subsequently, a liquid resin 110 is applied to a surface having a concavo-convex pattern of the master template 100. The concavo-convex pattern of the master template 100 is filled with the liquid resin 110 by capillary phenomenon. The liquid resin 110 used herein contains a pattern transferring component, a pattern retention component, and a stretch component. Each component will be described below.

Then, as shown in FIG. 2, the liquid resin 110 is irradiated with light or heated after the concavo-convex pattern of the master template 100 is filled with the liquid resin 110. Thus, the liquid resin 110 is hardened. In a case of irradiation with light, for example, UV irradiation may be performed.

As shown in FIG. 3, the hardened liquid resin 110 is released from the master template 100. Thus, a copy template 120 formed of the hardened liquid resin 110 (second template) is obtained. Since the liquid resin 110 contains a pattern transferring component, a fine concavo-convex pattern of the master template 100 is transferred to the copy template 120. For example, the pattern transferring component is a liquid silicon resin. A silicon polymer or silsesquioxane may be used. Further, as the pattern transferring component, a liquid substance in which a norbornene resin that is a raw material for a cyclic olefin polymer, an oxazole resin, a block copolymer of amide acid and silicone resin, or a silicon resin is dissolved in a solvent may be used. Moreover, as the pattern transferring component, a material for an artificial cartilage or soft diamond gel (tetra-polyethylene glycol gel) may be used.

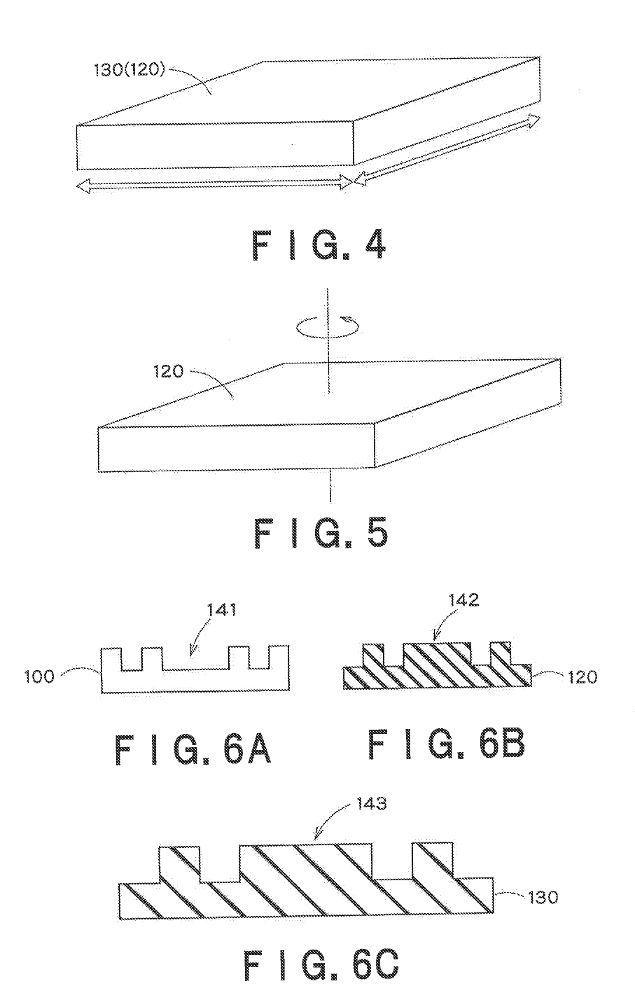

As shown in FIG. 4, the copy template 120 is heated and stretched. Heating is adjusted so that the copy template 120 is softened and the concavo-convex pattern of the copy template 120 is not deformed. In FIG. 4, the illustration of the concavo-convex pattern is omitted.

Since the material for the copy template 120 (liquid resin 100) contains a stretch component, the copy template is stretched by extension and enlarged. Thus, an enlarged copy template 130 is obtained. The material for the copy template 120 (liquid resin 110) contains a pattern retention component. Therefore, even when the copy template 120 is heated and stretched, the shape of the concavo-convex pattern is not deformed and is maintained. For example, the copy template 120 is enlarged 1.5 times or more to obtain the enlarged copy template 130.

The stretch component is a thermoplastic resin having no cyclic structure, and for example, PMMA (polymethylmethacrylate), PE (polyethylene), PP (polypropylene), PVA (polyvinyl alcohol), PA (polyamide) or POM (polyoxymethylene) may be used.

The pattern retention component is a thermoplastic resin having a cyclic structure, and for example, COP (cycloolefin polymer), PC (polycarbonate), PS (polystyrene), PET (polyethylene terephthalate), AS (acrylonitrile styrene) or ABS (acrylonitrile butadiene styrene) may be used. Further, a norbornene resin that is a raw material for a cyclic olefin polymer or an oxazole resin may be used as the retention component.

The copy template 120 may be stretched in one direction, in two orthogonal directions (see FIG. 4), or in three or more directions. When the number of directions to be stretched is one or more, a copy template may be stretched in a plurality of directions simultaneously or in each direction successively.

As shown in FIG. 5, the copy template 120 may be rotated with heating, and stretched in all directions.

A case where there is a defect 141 as shown in FIG. 6A in the concavo-convex pattern of the master template 100 is considered. Since a line portion is not formed in the defect 141, there is a defect in which a desired line and space pattern is not formed. The defect 141 is transferred to the concavo-convex pattern of the copy template 120 as a defect 142, as shown in FIG. 6B. The copy template 120 is then stretched and enlarged. Thus, an enlarged defect 143 appears in the concavo-convex pattern of the enlarged copy template 130, as shown in FIG. 6C.

Subsequently, a pattern face of the enlarged copy template 130 is scanned with an optical defect checking device to detect a defect. The optical defect checking device is equipped with a light source such as a mercury lamp and an argon laser, a condensing lens, an XY stage for mounting the enlarged copy template 130, an objective lens, and an image sensor. The XY stage has such a configuration that the enlarged copy template 130 can move in a planar two-axis direction (XY direction). The image sensor is, for example, a CCD sensor in which CCD (charge coupled devices) are arranged in one dimension or two dimensions.

For example, when the defect 141 in the concavo-convex pattern of the master template 100 is a fine defect having a size of 20 nm or less, it is very difficult to detect the defect 141 with the optical defect checking device. However, the enlarged defect 143 formed by enlarging the copy template 120 can be detected with the optical defect checking device.

When the enlarged defect 143 is detected, the position of the defect 141 in the master template 100 is calculated from the position of the enlarged defect 143 in the enlarged copy template 130 and the enlargement ratio of the enlarged copy template 130. For example, a standard pattern in the master template 100 is set, the size of an enlarged standard pattern corresponding to the standard pattern in the enlarged copy template 130 is compared with the size of the standard pattern, and the enlargement ratio of the enlarged copy template 130 is calculated. For example, the size of the standard pattern includes a line width of a line pattern, a diameter of a hole pattern, and a distance between two alignment marks.

After calculation of the position of the defect 141 in the master template 100, the defect is reviewed by SEM, and the defect in the master template 100 is modified by an electron beam modification device.

According to the embodiment, a copy template obtained by replication of a concavo-convex pattern of a master template is enlarged, and the enlarged copy template is checked to detect the presence or absence of a defect on the master template and the position of the defect.

In the first embodiment, when the amount of the stretch component in the liquid resin 110 is small, the enlargement ratio of the enlarged copy template 130 is not large. Therefore, it is preferable that the content of the stretch component be 30% or more. When the amount of the pattern retention component is small, the concavo-convex pattern is deformed during enlargement of the copy template 120. Therefore, it is preferable that the content of the pattern retention component is 5% or more. When the amount of the pattern transferring component is small, the concavo-convex pattern of the master template 100 cannot be transferred to the copy template 120. Therefore, it is preferable that the content of the pattern transferring component is 20% or more. For example, it is preferable that the liquid resin 110 include 50% of stretch component, 10% of pattern retention component, and 40% of pattern transferring component.

In the first embodiment, the position of the enlarged defect 143 is determined, and the position of the defect 141 is calculated in the accordance with the enlargement ratio of the enlarged copy template 130. Further, the shape is also determined in addition to the position.

### Second Embodiment

In the first embodiment, a copy template 120 is enlarged by heating and stretching. Here, while a copy template 120 is allowed to absorb an organic solvent and swollen, the copy template may be stretched and enlarged.

In this case, a liquid resin 110 for forming a copy template 120 contains a pattern transferring component, a pattern retention component, and a solvent-absorbing swelling component.

As the pattern transferring component, the same components as in the first embodiment may be used. For example, the pattern transferring component is a liquid silicon resin. A silicon polymer or silsesquioxane may be used.

As the pattern retention component, the same components as in the first embodiment may be used. For example, the pattern retention component is a thermoplastic resin having a cyclic structure. COP (cycloolefin polymer), PC (polycarbonate), PS (polystyrene), PET (polyethylene terephthalate), AS (acrylonitrile styrene) or ABS (acrylonitrile butadiene styrene) may be used.

The solvent-absorbing swelling component is a component that is swollen by absorbing an organic solvent, and for example, PMMA (polymethylmethacrylate), PU (polyurethane), a fluoride-contained resin, or PVA (polyvinyl alcohol) may be used. Further, a norbornene resin that is a raw material for a cyclic olefin polymer or an oxazole resin may be used as the swelling component. Moreover, as the swelling component, a material for an artificial cartilage or soft diamond gel (tetra-poly ethylene glycol gel) may be used. In particular, when soft diamond gel is used, the expansion ratio is as large as 100% to 1,000%. Therefore, the enlargement ratio is large. In addition, the expansion ratio variation is small. This is preferable.

As the organic solvent, HFP (hexafluoropropylene), OFP (octafluoropentanol), TFP (tetrafluoropropanol), HFE (hydrofluoroether), IPA (isopropyl alcohol), PGMEA, anisole, or NMP may be used. The copy template 120 is impregnated with an organic solvent, and as a result, the organic solvent is absorbed in the copy template 120. In the case of use of soft diamond gel, water may be used. In this case, the copy template 120 is allowed to absorb water and swollen.

Alternatively, a copy template 120 is put in a chamber, a gas such as PFP (pentafluoropropane), HFC (hydrofluorocarbon), and nitrogen is supplied, the pressure in the chamber is increased to condense the gas into a liquid, and the liquid may be absorbed in the copy template 120. In this case, it is preferable that a mechanism for stretching the copy template 120 be disposed in the chamber.

An enlarged copy template 130 may be checked in an organic solvent (liquid) or taken out the organic solvent (liquid) and then checked. When the enlarged copy template 130 is taken out an organic solvent (liquid), the organic solvent (liquid) may be vaporized from the enlarged copy template 130, but the enlarged copy template 130 can be prevented from shrinking due to the pattern retention component.

In the second embodiment, when the amount of the solvent-absorbing swelling component in the liquid resin 110 is small, the enlargement ratio of the enlarged copy template 130 cannot be large. Therefore, it is preferable that the content of the solvent-absorbing swelling component be 30% or more. When the amount of the pattern retention component is small, the concavo-convex pattern is deformed during enlargement of the copy template 120. Therefore, it is preferable that the content of the pattern retention component is 5% or more. When the amount of the pattern transferring component is small, the concavo-convex pattern of the master template 100 cannot be transferred to the copy template 120. Therefore, it is preferable that the content of the pattern transferring component is 20% or more. For example, it is preferable that the liquid resin 110 include 50% of solvent-absorbing swelling component, 10% of pattern retention component, and 40% of pattern transferring component.

### Third Embodiment

In the first embodiment, the copy template 120 is enlarged by heating and stretching. Here, a foaming component is contained in the copy template 120, the copy template 120 is heated, pressurized, or irradiated with light, and foaming occurs in the copy template 120. Thus, the copy template 120 may be swollen and enlarged. Moreover, the copy template 120 may be stretched while the copy template 120 is swollen by foaming.

In this case, the liquid resin 110 for forming the copy template 120 contains the pattern transferring component, the pattern retention component, the stretch component, and the foaming component.

As the pattern transferring component, the same components as in the first embodiment may be used. For example, the pattern transferring component is a liquid silicon resin. A silicon polymer or silsesquioxane may be used.

As the stretch component, the same components as in the first embodiment may be used. The stretch component is a thermoplastic resin having no cyclic structure, and for example, PMMA (polymethylmethacrylate), PE (polyethylene), PP (polypropylene), PVA (polyvinyl alcohol), PA (polyamide) or POM (polyoxymethylene) may be used.

As the pattern retention component, the same components as in the first embodiment may be used. The pattern retention component is a thermoplastic resin having a cyclic structure, and for example, COP (cycloolefin polymer), PC (polycarbonate), PS (polystyrene), PET (polyethylene terephthalate), AS (acrylonitrile styrene) or ABS (acrylonitrile butadiene styrene) may be used.

As the foaming component, an azo compound may be used.

When the amount of the stretch component in the liquid resin 110 is small, the enlargement ratio of an enlarged copy template 130 cannot be large. Therefore, it is preferable that the content of the solvent-absorbing swelling component be 30% or more. When the amount of the pattern retention component is small, the concavo-convex pattern is deformed during enlargement of the copy template 120. Therefore, it is preferable that the content of the pattern retention component is 5% or more. When the amount of the pattern transferring component is small, the concavo-convex pattern of the master template 100 cannot be transferred to the copy template 120. Therefore, it is preferable that the content of the pattern transferring component is 20% or more. When the amount of the foaming component is small, foaming does not sufficiently occur in the copy template 120 and the copy template 120 is not swollen. Therefore, it is preferable that the content of the foaming component is 5% or more. For example, it is preferable that the liquid resin 110 include 45% of stretch component, 10% of pattern retention component, 40% of pattern transferring component, and 5% of foaming component.

### Fourth Embodiment

In the first embodiment, a copy template 120 is enlarged by heating and stretching. Here, while a copy template 120 is allowed to inject a gas and swollen, the copy template may be stretched and enlarged.

As the gas injected into the copy template 120, an inert gas such as nitrogen and argon, or oxygen may be used.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for producing a template comprising:
applying a resin to a first template having a first concavo-convex pattern;
hardening the resin;
releasing the hardened resin from the first template to produce a second template having a second concavo-convex pattern corresponding to the first concavo-convex pattern; and
enlarging the second template.

2. The method for producing a template according to claim 1, wherein the resin includes a liquid silicon resin, a first thermoplastic resin, and a second thermoplastic resin having no cyclic structure.

3. The method for producing a template according to claim 2, wherein the second template is stretched and enlarged while being heated.

4. The method for producing a template according to claim 2, wherein the second template is stretched and enlarged while an organic solvent is absorbed.

5. The method for producing a template according to claim 2:
placing the second template in a chamber;
supplying a gas to the chamber;
condensing the gas in the chamber; and
stretching the second template while the condensed gas is absorbed in the second template.

6. The method for producing a template according to claim 2, wherein the resin further includes a foaming component, the second template is heated, pressurized, or irradiated with light, and foaming occurs in the second template to enlarge the second template.

7. The method for producing a template according to claim 6, wherein the second template is stretched while foaming occurs in the second template.

8. The method for producing a template according to claim 2 comprising injecting a gas into the second template to enlarge the second template.

9. The method for producing a template according to claim 8, wherein the second template is stretched while being swollen.

10. A method for checking a template comprising:
applying a resin to a first template having a first concavo-convex pattern;
hardening the resin;
releasing the hardened resin from the first template to produce a second template having a second concavo-convex pattern corresponding to the first concavo-convex pattern;
enlarging the second template;
comparing a size of the second enlarged concavo-convex pattern with that of the first concavo-convex pattern to determine an enlargement ratio;
checking the second enlarged template to detect a defect; and
calculating a position of a defect on the first template based on the position of the defect on the second template and the enlargement ratio.

11. The method for checking a template according to claim 10, wherein the size of the defect on the first template is calculated in accordance with the shape of the defect on the second template and the enlargement ratio.

12. A template material that is applied to a first template having a concavo-convex pattern, hardened, and released to form a second template, comprising a liquid silicon resin, a first thermoplastic resin, and a second thermoplastic resin having no cyclic structure.

13. The template material according to claim 12, further comprising a foaming component.

14. The template material according to claim 13, wherein the foaming component is an azo compound.

15. The template material according to claim 12, wherein the first thermoplastic resin contains a cycloolefin polymer, polycarbonate, polystyrene, polyethylene terephthalate, acrylonitrile styrene, or acrylonitrile butadiene styrene.

16. The template material according to claim 12, wherein the first thermoplastic resin contains polymethylmethacrylate, polyethylene, polypropylene, polyvinyl alcohol, polyamide, or polyoxymethylene.
